(19) United States
(12) Patent Application Publication
(10) Pub. No.: US 2026/0192613 A1
(43) Pub. Date: Jul. 9, 2026

(54) SYSTEM AND PROCESS FOR OPERATING A CENTRAL TIRE INFLATION SYSTEM FROM THE SPECTRAL CRITERIA OF EACH TIRE OF AN AGRICULTURAL VEHICLE

(71) Applicants: COMPAGNIE GENERALE DES ETABLISSEMENTS MICHELIN, Clermont-Ferrand (FR); PTG REIFENDRUCKREGELSYSTEME GMBH, Neuss (DE)

(72) Inventors: FABRICE GOIZET, Clermont-Ferrand (FR); CHRISTOPHER HAAG, Neuss (DE)

(21) Appl. No.: 19/124,597

(22) PCT Filed: Oct. 26, 2023
(86) PCT No.: PCT/EP2023/079889

§ 371 Date: Apr. 25, 2025

(30) Foreign Application Priority Data
Oct. 27, 2022 (FR) FR2211187

(51) Int. Cl. B60C 23/00; A01B 76/00

(52) U.S. Cl. CPC B60C 23/001; A01B 76/00; B60C 2200/08

(57) ABSTRACT

A tire pressure recommendation process (1000) for controlling a CTIS system (105, 205) of an agricultural system (100, 200, 300) having at least one processor in operational communication with at least one memory is configured to execute the tire pressure recommendation process. The at least one processor comprises an execution module that is capable of executing programming instructions that are stored in the memory for performing the tire pressure recommendation process, such that, on the basis of a selected usage condition, the system (100, 200, 300) communicates a recommended pressure for at least one tire (12a, 14a, 34) to the CTIS system (105, 205).

### TECHNICAL DOMAIN

The disclosed invention is directed to a system and process for operating a central tire inflation system (CTIS) by estimating a load borne by each tire of an agricultural vehicle having the CTIS installed therewith. In particular, the invention is directed to a system and a process implemented by the disclosed system for operating a CTIS from the spectral criteria of each tire of an agricultural vehicle having the CTIS installed therewith.

### BACKGROUND

In the agricultural domain, it is well understood that management of tire inflation pressure can attenuate compaction concerns so as to improve vehicle performance on various surfaces (including, but not limited to, soil, rocky terrain, grassy terrain, sandy terrain, road surfaces and other surface types). Such concerns are weighed against the need to minimize wheel slip, particularly in view of the negative impacts of heavy tillage and planting upon the vehicle as well as any implement pulled thereby.

The use of central tire inflation systems (or “CTIS” systems) is a common approach to vehicle set-up that enables control of the air pressure in each tire mounted on an agricultural vehicle. There are multiple types of CTIS systems disclosed by prior art. For example, U.S. Pat. No. 9,579,935 discloses a tire management system for an off-road work vehicle having a first load sensor coupled to a first axle of the vehicle and a first pressure sensor configures to determine a pressure within a tire coupled to the first axle. The first load sensor is a first strain sensor that is configured to determine a first deformation of the first axle and a first load placed on the first tire based at least in part on the first deformation. A control unit in communication with the first load sensor and the first pressure sensor is configured to generate a first fluid pressure adjustment instruction based at least in part on the first load determined by the first load sensor and the first fluid pressure determined by the first pressure sensor. A valve in fluid communication with the first tire is configured to adjust the first fluid pressure within the first tire based at least in part on the first fluid pressure adjustment instruction.

In another example, U.S. Pat. No. 10,596,868 discloses a tire pressure control and regulation process for agricultural use. The process includes a step of measuring a tire pressure; a step of measuring a footprint or deflection of the tire; a step of determining a calculated value of the load applied to the tire as a function of the measured footprint or deflection; a step of determining an optimum pressure value corresponding to the calculated value of the applied load; a step of determining a calculated value of the footprint or of the deflection as a function of the optimum pressure value; and a step of modifying the tire pressure to reduce a difference between the measured and optimum pressure values. The process steps can be repeated until the measured value and the calculated value of the footprint or of the deflection are equal.

U.S. Pat. No. 10,675,924 discloses a tire inflation system for an agricultural system that includes a controller having a memory and a processor, wherein the controller is configured to perform an iterative process until a stopping condition is reached. The iterative process includes a step of receiving a tire pressure sensor signal indicative of a tire pressure of at least one tire of a vehicle and/or and implement of the agricultural system; a step of receiving a draft load sensor signal indicative of a draft load on the vehicle; a step of determining a draft load difference between the draft load and a maximum draft load; and a step of outputting a target tire pressure output signal indicative of instructions to adjust the tire pressure of the tire of the vehicle and/or the implement in response to a determination that the draft load difference is greater than or equal to a first threshold.

US Publication 2020/0247194 discloses an agricultural implement having an automatic tire inflation system that adjusts a pressure of at least tire coupled thereto. The tire inflation system includes a first sensor that detects a weight of the agricultural implement, and a controller that receives feedback from the first sensor so as to automatically adjust the pressure of the at least one tire based on at least the weight of the agricultural implement. It is understood that known CTIS systems can also be used with a variety of agricultural systems that incorporate different configurations of agricultural vehicles and implements. For example, referring to FIG. 1, a known CTIS system may be used in an agricultural system having a tractor 10 (as used herein, the term “tractor” refers to a type of agricultural vehicle, although it is understood that the CTIS system is suitable for use with equivalent polyvalent vehicles that may not be limited to agricultural applications). The tractor 10 includes a front axle 12 that serves as an axis of rotation supporting one or more front tires 12a. The tractor 10 also includes a rear axle 14 that serves as an axis of rotation supporting one or more rear tires 14a. Each tire 12a, 14a, having a respective tread that contacts the ground surface, is in a wheel-mounted state to constitute an assembly mounted in a running condition at a rotational speed W. The tractor 10 may be operated alone or together with one or more attached implements 20 attached to the front axle 12 and/or one or more implements 22 attached to the rear axle 14 for which the operator requires information about weight, center of gravity and their effects on the tractor's axle load distribution. Examples of commonly employed implements include, but are not limited to, box blades, mowers, front end loaders, rear blades, plows, post hole diggers, back hoes, snow blowers, land planes, rotary tillers, pallet forks and spreaders.

As shown in FIG. 1, the pressure of each tire 12a, 14a of the tractor 10 can be adjusted independently by a known CTIS system 105 that includes a compressor 105a. The compressor 105a receives and compresses ambient air for eventual output to one or more of the tires 12a, 14a in response to signals received from one or more sensors 101 mounted inside each tire 12a, 14A. The compressor 105a may be in communication with a reservoir (not shown) that stores compressed air for subsequent delivery to one or more of the tires 12a, 14a. An operator of the tractor 10 can control the distribution of compressed air from the compressor to at least one corresponding tire 12a, 14a. For example, a controller in communication with the compressor 105a, and via at least one processor (not shown), receives the signals transmitted by the sensors 101 and displays the corresponding tire pressure on a user interface 104. From the user interface 104, the operator can adjust the pressure of a corresponding tire 12a, 14a. Such pressure adjustment may be performed one or several times during operation of the tractor 10, or it may be performed iteratively as a function of the surface being treated and the load borne by the tires 12a, 14a (for example, until a target tire pressure is attained for the corresponding tire).

The employment of embedded sensors in agricultural systems facilitates the development of services related to the monitoring of connected tire assemblies incorporated in such systems. Thus, the disclosed invention is directed to a solution that employs connected tire assemblies in an agricultural system incorporating at least one agricultural vehicle and at least one CTIS system. The disclosed invention enables the spectral criteria that is derived from each tire of the agricultural vehicle (including each tire mounted to an implement coupled to such vehicle) to be employed in the calculation of a recommended pressure for each such tire. The CTIS system can be operated in correspondence with such recommended tire pressure so as to select and/or adjust this pressure accordingly.

### SUMMARY OF THE INVENTION

The invention is directed to a tire pressure recommendation process for controlling a central tire inflation system (CTIS system) of an agricultural system having at least one processor in operational communication with at least one memory that is configured to execute the tire pressure recommendation process, the tire pressure recommendation process including a step of installation of at least one sensor along an interior surface of at least one of a vehicle tire of an agricultural vehicle and/or a trailer tire of a trailer coupled with the agricultural vehicle so as to be positioned essentially normal with respect to the respective tread of each tire, with each sensor being capable of transmitting data representative of the operational parameters of the respective tire;
characterized in that the at least one processor includes an execution module that is capable of executing programming instructions that are stored in the memory for performing the tire pressure recommendation process including the following steps:
   a step of transmitting data from each sensor to a corresponding receiver of the agricultural system, with each receiver including or being in communication with the at least one processor that treats the received data so as to derive spectral criteria F_{c} for at least one of a corresponding tire;
   a step of performing a post treatment procedure on the signal generated by each sensor during which the spectral criteria F_{c} is obtained for the at least one tire; and
   a step of performing a pressure recommendation procedure during which the spectral criteria obtained during the post treatment procedure is employed in calculating a recommended tire pressure for the at least one tire;
such that, on the basis of a selected usage condition for the at least one tire, the system communicates a recommended pressure for the at least one tire to the CTIS system.

In certain embodiments of the process of the invention, wherein the post-treatment procedure executed by the at least one processor includes the following steps:
a step of acquisition of a first temporal signal Sig from each sensor, wherein the first signal Sig includes at least the amplitude of at least one output signal during rotation of a corresponding tire;
a step of determination of at least one reference speed W_{ref} of the corresponding tire associated with at least a portion of a wheel rotation signal Sig_{TdR} of the corresponding vehicle tire;
a step of normalization of the wheel rotation signal Sig_{TdR} that is obtained from the first signal Sig, during which step at least one part of the wheel speed signal Sig_{TdR} is normalized by a quantity that is a function F proportional to the square of the reference speed W_{ref} over a predetermined number of revolutions of the corresponding tire; and
a step of resampling the normalized signal acquired at the output of the normalization step so as to obtain a signal that is angularly periodic per tire revolution.

In certain embodiments of the process of the invention, the step of determination of at least one reference speed W_{ref} includes determination of a ratio of an angular variation on a time duration separating two azimuthal positions of the sensor in the corresponding tire around the natural axis of rotation from the first signal Sig or from a signal phased with the first signal Sig, according to the following formula:

$${W}_{ref} = Δ ( α ) / Δ ( t ) \qquad [ Math 1 ]$$

where α is the angular position and t is the time abscissa associated with the angular position. In certain embodiments of the process of the invention, the post treatment procedure executed by the at least one processor includes a step of aggregating the data of the angularly normalized resampled wheel revolution signal Sig_{TdR}, and wherein the data aggregation is performed on a sub-part of the input signal Sig that is a predetermined multiple of wheel revolutions.

In certain embodiments of the process of the invention, the pressure recommendation procedure executed by the at least one processor includes the following steps:
a step of determining a raw pressure recommendation advice for each speed at which the corresponding tire travels;
a step of calculating a recommended pressure for the corresponding tire; and
a step of applying a selected usage condition to the calculated pressure obtained from the step;
   such that, on the basis of the selected usage condition, the system communicates a recommended pressure for the corresponding one tire to the CTIS system.

In certain embodiments of the process of the invention, the step of calculation of a recommended pressure for the corresponding tire includes a step of determination of a recommended pressure P_{DB} performed on the basis of the spectral criteria F_{c} that is obtained during the post treatment procedure and on the basis of a pressure measurement P_{C} of the corresponding tire, according to the following formula:

$${P}_{DB} = {[ \frac{{( {F}_{c}^{a 3} * {P}_{C}^{a 2} * a 1 )}^{\frac{1}{a 2}}}{{α}^{\frac{a 3}{a 2}} * a {1}^{\frac{1}{a 2}}} ]}^{\frac{a 2}{β * a 3 + a 2}} \qquad [ Math 2 ]$$

where a1, a2 and a3 are predefined coefficients, and where a and B are defined for each line speed in the raw pressure recommendation advice.

In certain embodiments of the process of the invention, the step of applying a selected usage condition executed by the at least one processor includes the following steps:
a step of selecting tire pressures value P_{DB} when the detected speed index i of a sensed tire is greater than a predetermined minimum speed;
a step of indication of whether the indicated usage condition constitutes intensive road usage, wherein:
when intensive road usage is indicated, the step of applying a selected usage condition includes a step of determination of an adjusted usage pressure P_{DBi} for each speed index i according to the following formula:

$${P}_{DBi} = {P}_{DBi} + 0.4 ; \qquad [ Math 3 ]$$

a step of determination of a current state of the CTIS system, wherein;
when use of the CTIS system is indicated, the step includes:
   a step of indication of whether the tire concerned by the pressure recommendation is a tire identified for use with the vehicle and/or with the trailer;
   a step of verification to verify whether the identified tire is a tire selected for use with one or more of the vehicle and the trailer; and
   a step of applying a minimum predefined pressure (P_{min·}, P_{min′});
and a step of determination of whether the adjusted usage pressure P_{DBi} has several values, wherein;
when the determined adjusted usage pressure P_{DBi} does not have several values, the step includes a step of producing a recommended pressure P according to the following formula:

$$P = max ( {P}_{DB} , {P}_{min} ) ; \qquad [ Math 5 ]$$

and when the determined adjusted usage pressure P_{DBi} does have several values, the step of determination of whether the adjusted usage pressure P_{DBi} has several values includes a step of interrogation of the operational speed of the corresponding tire, which step includes a step of producing a recommended pressure P according to the following formula:

$$P = max ( {P}_{DB} speed , {P}_{min} ) . \qquad [ Math 6 ]$$

In certain embodiments of the process of the invention, wherein the step of applying a selected usage condition executed by the at least one processor includes the following steps:
a step of indication of whether the indicated usage condition constitutes cyclic values for each pressure P_{DB}, wherein;
when cyclic values are indicated, the step of applying a selected usage condition includes a step of selecting a pressure P_{DB} without cyclic values;
a step of indication of whether the indicated usage condition constitutes heavy torque usage, wherein:
   when no heavy torque usage is indicated, the step of applying a selected usage condition includes a step of selecting a P_{DB} value with a minimum speed value according to the following formula:

$${P}_{DB} = ( {P}_{DBmin ( i )} ) ; \qquad [ Math 7 ]$$

and when heavy torque usage is indicated, the step of applying a selected usage condition includes a step of determining whether a pressure exists at a selected speed P_{DB speed}, wherein:
when a pressure at a selected speed P_{DB speed} is determined during the selection of a value for P_{DB}, the selection of a value for P_{DB} is made according to the following formula:

$${P}_{DB} = {P}_{DBspeed} ; \qquad [ Math 8 ]$$

and when no pressure at a selected speed P_{DB} speed is determined during the selection of a value for P_{DB}, the pressure recommendation procedure includes a step of determination of a whether a maximum speed exceeds a predefined selected speed, wherein:
when no maximum speed is determined during the step of determination of whether a maximum speed exceeds a predefined selected speed, such step includes a determination of the recommended pressure P_{DB} according to the following formula:

$${P}_{DB} = {P}_{DBmax} ; \qquad [ Math 9 ]$$

where P_{DBmax} is a pressure at the maximum speed;
and when a maximum speed is determined during the step of determination of whether a maximum speed exceeds a predefined selected speed, such step includes a selection of a value for P_{DB} according to the following formula:

$${P}_{DB} = {P}_{DB ( min ( i )} . \qquad [ Math 11 ]$$

In certain embodiments of the process of the invention, wherein the step of applying a selected usage condition includes a step of indication of whether the indicated usage condition constitutes slope usage, wherein:
when no slope usage is indicated, the pressure recommendation procedure produces a recommended pressure P on the basis of the following formula:

$$P = {P}_{DB} ; \qquad [ Math 12 ]$$

and, when slope usage is indicated, the pressure recommendation procedure includes a step of determination of an adjusted recommended pressure P_{DB} according to the following formula:

$${P}_{DB} = {P}_{DB} + 0.4 . \qquad [ Math 13 ]$$

In certain embodiments of the process of the invention, one or more steps of the process (1000) is performed iteratively.

The invention is also directed to an agricultural system that performs the tire pressure recommendation process of the invention, including:
an agricultural vehicle including a front axle that serves as an axis of rotation supporting one or more front tires, and a rear axle that serves as an axis of rotation supporting one or more rear tires, with each tire having a respective tread that contacts the ground surface and being in a wheel-mounted state so as to constitute an assembly mounted in a running condition at a rotational speed W;
at least one sensor installed along an interior surface of each tire so as to be positioned essentially normal with respect to the respective tread with each sensor being capable of transmitting data representative of the operational parameters of the respective tire;
at least one receiver that receives the data transmitted by each sensor, with each receiver including or being in communication with the at least one processor so as to derive spectral criteria for at least one corresponding tire;
at least one user interface in communication with the receiver that displays tire pressure information corresponding to the signals received from the sensors and treated by the receiver during the post-treatment procedure of the tire pressure recommendation process; and
at least one central tire inflation system (CTIS system) installed in the agricultural vehicle that permits independent adjustment of the pressure of the at least one corresponding tire.

The invention is also directed to an agricultural system that performs the tire pressure recommendation process of the invention, including:
an agricultural vehicle including a front axle that serves as an axis of rotation supporting one or more front tires, and a rear axle that serves as an axis of rotation supporting one or more rear tires, with each tire having a respective tread that contacts the ground surface and being in a wheel-mounted state so as to constitute an assembly mounted in a running condition at a rotational speed W;
a trailer coupled to the agricultural vehicle including one or more axles that serve as an axis of rotation supporting one or more trailer tires each having a respective tread that contacts the ground surface and being rotatably mounted in a wheel-mounted state so as to constitute an assembly mounted in a running condition at a rotational speed W′;
at least one sensor installed along an interior surface of each trailer tire so as to be positioned essentially normal with respect to the respective tread with each sensor being capable of transmitting data representative of the operational parameters of the respective trailer tire;
at least one receiver that receives the data transmitted by each sensor, with each receiver including or being in communication with the at least one processor so as to derive spectral criteria for at least one corresponding trailer tire;
at least one user interface in communication with the receiver that displays tire pressure information corresponding to the signals received from the sensors and treated by the receiver during the post-treatment procedure of the tire pressure recommendation process; and
at least one central tire inflation system (CTIS system) installed in the trailer that permits independent adjustment of the pressure of the at least one corresponding trailer tire. The invention is also directed to an agricultural system that performs the tire pressure recommendation process of the invention, including a combination of the disclosed agricultural systems.

In each of the agricultural systems disclosed herein, each sensor includes an accelerometer that is capable of detecting temperature and/or pressure values in the interior of at least one respective tire.

In certain embodiments of each of the agricultural systems disclosed herein, the agricultural vehicle includes at least one of:
one or more implements attached to the front axle; and
one or more implements attached to the rear axle.

Other aspects of the invention will become evident in view of the following detailed description.

### BRIEF DESCRIPTION OF THE DRAWINGS

The nature and various advantages of the invention will become more apparent from the following detailed description in conjunction with the accompanying drawings, in which the same reference numerals designate identical parts throughout, and in which:

FIGS. 1, 2 and 3 represent embodiments of agricultural systems that perform a tire pressure recommendation process of the invention.

FIG. 4 represents a schematic flow diagram of an embodiment of the tire pressure recommendation process of the invention.

FIG. 5 represents a flow diagram of a post-treatment procedure of the tire pressure recommendation process of the invention.

FIG. 6 represents a flow diagram of a pressure recommendation procedure of the tire pressure recommendation process of the invention.

FIG. 7 represents an exemplary relationship between spectral criteria and tire pressure that is employed during the tire pressure recommendation process of the invention.

### DETAILED DESCRIPTION

As used herein, the terms “radially,” “axially,” and “circumferentially” mean “in a radial direction,” “in the axial direction,” and “in a circumferential direction” of the referenced tire, respectively. The terms “radially inward” and “radially outward” respectively mean “closer to”, or “further from”, the axis of rotation of the referenced tire in a radial direction. Thus, the circumferential direction, the axial direction and the radial direction are understood herein to be directions defined with respect to the rotational reference frame of each tire 12a, 14a about its natural axis of rotation. The radial direction is the direction perpendicular to the natural axis of rotation. The axial direction is the direction parallel to the natural axis of rotation. Finally, the circumferential direction forms a direct triad with the predefined radial and axial directions.

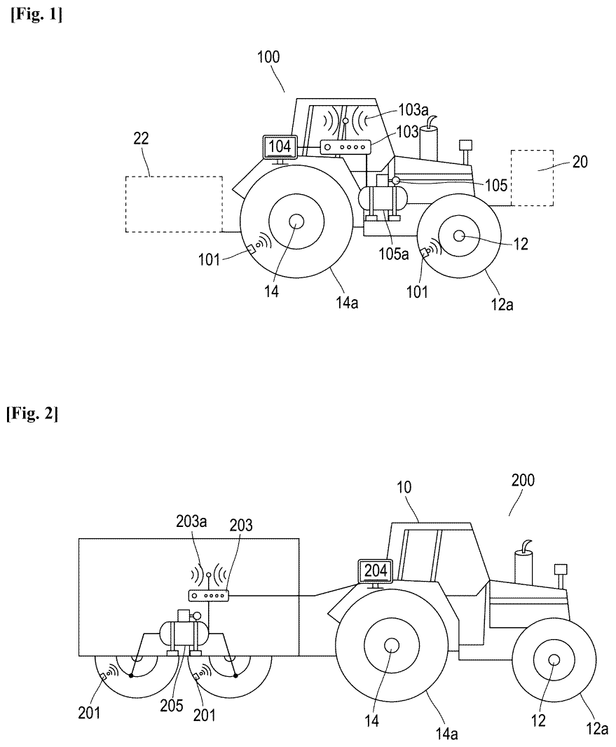

Now referring to the figures, in which the same numbers identify identical elements, an exemplary agricultural vehicle with which the present invention is employed is represented in by a tractor 10 as described hereinabove (see FIGS. 1, 2 and 3). With particular reference to FIG. 1, an agricultural system 100 of the invention includes the tractor 10 and at least one sensor 101 installed in each front tire 12a and in each rear tire 14a of the tractor. In this configuration, each sensor 101 can transmit data representative of the operational parameters of the respective tire to a receiver 103 of the system that is in radio communication with each sensor. Each sensor 101, which may be selected from one or more commercially available sensors, is installed along an interior surface of each tire 12a, 14a so as to be positioned essentially normal with respect to the respective tread. In embodiments of the system 100, the sensor is an accelerometer that is capable of detecting temperature and/or pressure values in the interior of each tire 12a, 14a.

The system 100 also includes at least one receiver 103 that receives the data transmitted by each sensor 101. In an embodiment of the system 100, the receiver 103 includes at least one antenna 103a that receives radio signals from the sensors 101. While the receiver 103 is represented as being carried on or in the tractor 10, it is understood that the receiver may be integrated in a one or more communication devices (or “devices”) that are connected to a communication network that manages data incoming to the system 100 from various sources. Such communication device(s) can include a wearable device(s) such as a mobile network device (e.g., a cell phone, a laptop computer, a network-connected wearable device(s), including “augmented reality” and/or “virtual reality” type devices, and/or any combinations and/or equivalents). The communication network may include wired or wireless connections and may implement any data transfer protocol known to a person skilled in the art. Examples of wireless connections may include, without limitation, radio frequency (RF), satellite, cell phone (analog or digital), Bluetooth®, Wi-Fi, infrared, “ZigBee”, local area network (LAN), wireless local area network (WLAN), wide area network (WAN), near field communication (NFC), other wireless communication configurations and standards, their equivalents, and a combination thereof.

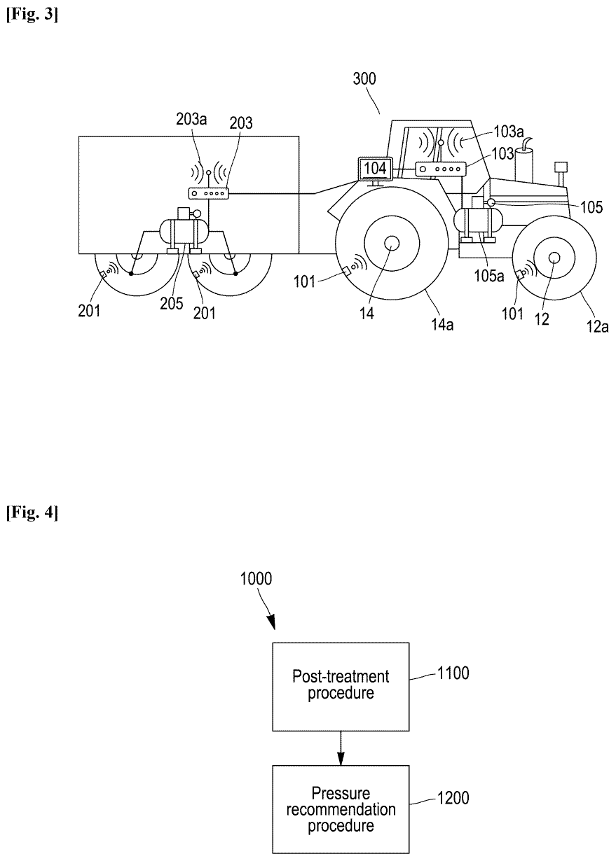

The receiver 103 includes (or is in communication with) one or more processors that treat the received data so as to derive spectral criteria for the corresponding tire 12a, 14a. Each processor is in operational communication with at least one memory that is configured to execute a tire pressure recommendation process 1000 of the invention for controlling the CTIS system 105 installed with the tractor 10 (this process is described and represented herein with respect to FIGS. 4 to 6).

The CTIS system 105 permits adjustment (that is, inflation or deflation) of the pressure of any tire 12a, 14a independently of the other tires. The CTIS system 105 can be selected from among known commercially available CTIS systems.

The at least one processor includes an execution module that is capable of executing programming instructions that are stored in the memory for performing the process 1000, during which spectral criteria is derived from each tire and employed in the calculation of a recommended tire pressure. During execution of the process 1000, the processor can access a raw pressure recommendation advice for each speed at which the corresponding tire travels. This advice is used to arrive at a recommended pressure for the tire. The raw pressure recommendation advice can include tire pressure advice for operation of the tractor 10 alone as well as pressure advice for operation of the tractor 10 when it is coupled with one or more implements 20 and/or 22. The processor, which communicates the recommended pressure to the operator of the tractor 10 for validation, sends an appropriate pressure adjustment command to the CTIS system 105 in view of the use conditions of the tractor 10 (for example, road use or field use).

The receiver 103 can include at least one processor that manages data corresponding to historical information and general information regarding the tires 12a, 14a. The term “historical information” (in the singular or plural) is used herein to refer to data corresponding to the historical trips of the tractor 10 having a specified tire 12a, 14a mounted thereon (or a tire that is identical or equivalent to the specified tire 12a, 14a). This data may include, but is not limited to, data corresponding to dates of departure and/or arrival of the tractor 10 at a predetermined location (e.g., a vehicle storage building, a field having specific coordinates, etc.), the routes taken by the tractor 10, general data about the tractor 10 (including, but not limited to, the manufacturer, the model of the tractor and its version, the tractor's identification code, etc.), and histories of the environmental, meteorological, and/or climatic conditions during prior operation of the tractor. The historical information can also include the historical loads observed for the tractor 10 having the tires 12a, 14a mounted thereon and the appropriate weight balances that correspond to such loads under a variety of operating conditions. The historical information can further include any ballast adjustments effected under the variety of operating conditions.

The term “general information” (in the singular or plural) is used herein to refer to the data corresponding to a front tire 12a and/or a rear tire 14a. This data may include, but is not limited to, its size (which may be represented by the type of tire and/or its nomenclature), its construction code (e.g., “R” for radial), its production source (e.g., the name and/or brand of the producer of the tire, its date and place of manufacture, distribution and/or storage), its unique identification number (or “serial number”), its load index, its speed symbol (for example, “A5” representing 25 km/h), and/or its expected mileage. For example, for a 710/70R42 size tire, the number “710” represents the nominal section width of the tire in millimeters, the number “70” represents the aspect ratio of the tire, the letter “R” represents a radial tire, and the number “42” represents the rim diameter in inches.

The term “processor” (or, alternatively, the term “programmable logic circuit”) (in the singular or plural) refers to one or more devices capable of processing and analyzing data and including one or more software programs for processing the same (e.g., one or more integrated circuits known to the person skilled in the art as being included in a computer, one or more controllers, one or more microcontrollers, one or more microcomputers, one or more programmable logic controllers (or “PLCs”), one or more application-specific integrated circuits, one or more neural networks, and/or one or more other known equivalent programmable circuits). The processors include software for processing the data captured and transmitted by the sensors 101 as well as software for identifying and locating variances and identifying their sources for correction.

In the system 100, the memory may include both volatile and non-volatile memory devices. Non-volatile memory may include solid state memory, such as NAND flash memory, “keep-alive memory” or “KAM” for saving various operating variables while the processor is powered down, magnetic and optical storage media, or any other suitable data storage device that retains data when the system 100 is powered down or loses power. The volatile memory may include static and dynamic RAM that stores program instructions and data, including a machine learning application.

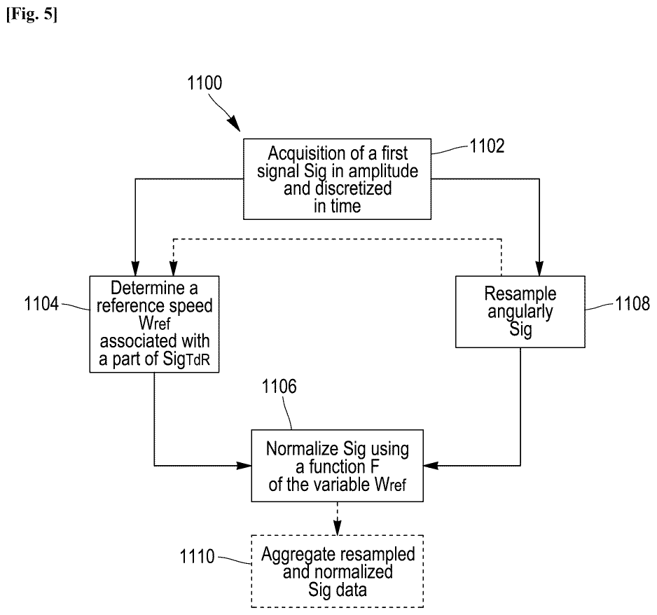

Still referring to FIG. 1, the system 100 further includes at least one user interface 104 in communication with the receiver 103. The user interface 104 displays tire pressure information for each tire 12a, 14a corresponding to the signals received from the sensors 101 and treated by the receiver 103 during a post-treatment procedure 1100 of the process 1000 (see FIGS. 4 and 5). The operator of the tractor 10 can therefore easily adjust the pressure of each tire 12a, 14a as needed (for example, by managing the tire inflation pressure of one or more of tires 12a, 14a using the CTIS system 105). For example, the operator of the tractor 10 can use the user interface 104 to verify the recommended tire pressure recommendation that corresponds to a defined usage condition. As the pressure information is displayed, the sensors 101 detect the revised tire load and generate corresponding signals for transmission to the receiver 103. The receiver 103 awaits the next update of the sensor signal so as to reiterate the detection and transmission of the tire pressure signal and communicate the updated tire pressure to the user interface 104.

The user interface 104 may incorporate one or several types of interfaces, including, but not limited to, a graphical user interface (or “GUI”), a command-line interface (or “CLI”), a menu-driven interface (or “MDI”), a form-based interface (or “FBI”), and/or a natural language user interface (or “NLI”). In an embodiment of the user interface 104, the user interface includes a graphical user interface that communicates the sensed tire pressure for each tire 12a, 14a to the operator (as determined by the receiver 103 in accordance with a process of the invention described herein). In this embodiment, the user interface 104 can include a graphical representation of the tire pressure in an image field and/or a text-based representation of the signal data in a text field. The image field and/or the text field may be updated regularly or intermittently in a manner that communicates whether the detected pressure for each tire 12a, 14a falls within predetermined thresholds for operation of the tractor 10 in the current operating conditions.

It is understood that a person of ordinary skill in the art would anticipate the integration of equivalent user interfaces. The user interface 104 may incorporate one or more I/O devices (including but not limited to displays, keyboards, keypads, mice and/or other pointing devices, trackballs, joysticks, haptic feedback devices, motion feedback devices, voice recognition devices, visual recognition devices (including facial recognition devices), digital imprint recognition devices, microphones, speakers, touch screens, touchpads, webcams, one or more cameras, gesture capture and recognition devices, devices incorporating touchless technologies and equivalent and complementary devices that enable operative response to user commands and inputs). It is understood that user input may be received via a computing device coupled to another computing device over a network.

Now referring further to FIG. 2, an agricultural system 200 of the invention includes the tractor 10 and a trailer 30 coupled thereto (coupled, for example, by one or more known vehicle coupling systems). The trailer 30 includes one or more axles 32 that serves as an axis of rotation supporting one or more trailer tires 34 each having a respective tread that contacts the ground surface. Each trailer tire 34 is rotatably mounted in a wheel-mounted state so as to constitute an assembly mounted in a running condition at a rotational speed W′. It is understood that the trailer 30 may be substituted by an equivalent conveyance means as is known in the art.

The system 200 includes at least one sensor 201 installed in each trailer tire 34. The sensor 201, like the sensor 101, is selected from one or more commercially available sensors and installed along an interior surface of each trailer tire 34 so as to be positioned essentially normal with respect to the respective tread. In embodiments of the system 200, the sensor 201 is an accelerometer that is capable of detecting pressure values in the interior of each trailer tire 34. Each sensor 201 is capable of transmitting data representative of the operational parameters of the respective tire 34.

The system 200 includes at least one receiver 203 installed in the trailer 30 and having an antenna 203a incorporated therewith. The system 200 also includes a CTIS system 205 installed on the trailer 30 and having at least one compressor 205. The receiver 203 and the CTIS system 205 function in the same manner as the receiver 103 and the CTIS system 105 of the agricultural system 100, except that the signals received and treated by the receiver 203 represent the pressure and acceleration data generated in each trailer tire 34.

The system 200 further includes a user interface 204 that is installed in the tractor 10. The user interface 204 may be selected from the types of interfaces described hereinabove with respect to the agricultural system 100.

Now referring further to FIG. 3, an agricultural system 300 of the invention is provided that includes a combination of the tractor 10 and the trailer 30 as described hereinabove with respect to FIGS. 1 and 2. In this configuration, the incorporation of a CTIS system in each of the tractor 10 and the trailer 30 permits independent pressure adjustment of the tractor tires 12a, 14a and independent adjustment of the trailer tires 34. Each of the tractor 10 and the trailer 30 incorporates all the other elements shown in FIGS. 1 and 2, respectively.

It is understood that other agricultural system configurations may employ the present invention. For example, an agricultural system of the type shown in FIG. 3 may not include a sensor, receiver and CTIS system combination in one of the tractor 10 and the trailer 30. Referring again to FIGS. 1 to 3, and further to FIGS. 4 to 6, a detailed description is given of exemplary embodiments of a tire pressure recommendation process (or “process”) 1000 of the invention. As used herein, the term “process” may include one or more steps performed by at least one computer system (for example, the receiver 103, 203) having a processor or processors to execute instructions that perform the steps of the process. Unless otherwise noted, any sequence of steps is illustrative and does not limit the described processes to any particular sequence.

Throughout the process 1000 of the invention, the sensors 101, 202 generate and send to the respective receiver(s) 103, 203 the signals that are required to obtain the spectral criteria of a respective tractor tire 12a, 14a and/or a respective trailer tire 34. It is therefore understood that the disclosed process may be performed by any one of systems 100, 200 and 300. It is further understood that the process of the invention is amenable to performance by equivalent and/or complementary agricultural systems that incorporate one or more CTIS systems. Upon initiation of the process 1000 of the invention, the process includes a step of performing a post-treatment procedure 1100 on the signal generated by each sensor 102. With particular reference to FIG. 5, the post treatment procedure 1100 includes a step 1102 of obtaining a first signal Sig. In considering the agricultural system 100, the first signal Sig that is acquired from each sensor 101 is the temporal amplitude of the acceleration of the sensor during rotation of the mounted tire assembly incorporating a corresponding tire 12a, 14a (i.e., the tire mounted on a rim on the tractor 10 with the sensor 101 positioned along an interior surface thereof). Thus, the acquired signal shows the variations in amplitude over a part of the circumference of the tire. These variations may include those associated with the crossing of the contact area by the part of the tire where the sensor 101 is fixed. These variations may also include those associated with other specific zones of the tire circumference (for example, a zone corresponding to the angular sector opposite the contact area) that are sensitive to the counter deflection or that correspond to the angular sectors located at 90 degrees of the contact area in relation to the axis of rotation. In all of these areas, accelerometer-like variations in sensor motion are potentially observable on the output signal depending on the sensitivity of the sensor.

In an agricultural system of the type represented by the system 200, this step 1102 is performed on the signal generated by each sensor 201 that is mounted in a corresponding trailer tire 34. Thus, the first signal Sig that is acquired from each sensor 201 is the temporal amplitude of its acceleration during rotation of the mounted tire assembly incorporating a corresponding trailer tire 34.

In an agricultural system of the type represented by the system 300, this step 1102 is performed on the signal generated by each sensor 101 that is mounted in a corresponding tractor tire 12a, 14a and by each sensor 201 that is mounted in a corresponding trailer tire 32. Thus, the first signal Sig that is acquired from each sensor 101, 201 is the temporal amplitude of the acceleration of the sensor during rotation of each mounted tire assembly incorporating a corresponding tractor tire 12a, 14a and each mounted tire assembly incorporating a corresponding trailer tire 34, respectively.

In order to obtain this first signal Sig, different embodiments of the post treatment procedure 1100 share steps that facilitate acquisition of a scalar representative of the applied load of the finally mounted tire assembly incorporating a tire 12a, 14a. In a first embodiment of the post treatment procedure, the step 1102 of obtaining the first signal Sig includes a step 1104 of determining a reference speed W_{ref} of the corresponding tractor tire 12a, 14a (and/or the corresponding trailer tire 34) in its mounted assembly configuration. During this step 1104, the first signal Sig is already delimited over a predetermined number of revolutions.

The reference speed W_{ref} can be an angular speed linked to the natural rotation of a tractor tire 12a, 14a (and/or a trailer tire 34) around its axis of rotation. Using the time signal generated at the output of step 1102, this reference speed W_{ref} can also be the linear translation speed of the corresponding tire 12a, 14a (and/or the corresponding trailer tire 34) according to its direction of movement. The first signal Sig, having been already delimited over a predetermined number of revolutions, is consequently confused with a wheel rotation signal Sig_{TdR}.

While the reference speed W_{ref} can be determined from the wheel rotation signal Sig_{TdR}, it can also be determined from another signal phased in time with the first signal Sig (and thus the wheel rotation signal Sig_{TdR}). In an embodiment of the disclosed process, the step 1104 of determining the reference speed W_{ref} includes a step of determining the ratio of the angular variation to the time duration separating two azimuthal positions of the sensor in a tire in which the sensor is installed. This ratio of angular variation is determined relative to the natural axis of rotation from the wheel turn signal Sig_{TdR} or from a signal phased with the wheel turn signal Sig_{TdR}, according to the following formula:

$${W}^{reference} = Δ ( α ) / Δ ( t ) \qquad [ Math 1 ]$$

where α is the angular position and t is the time abscissa associated with the angular position. In the case where the reference speed W_{ref} corresponds to the angular rotation speed of the corresponding tractor tire 12a, 14a (and/or the corresponding trailer tire 34), this reference speed is calculated on the basis of an angular variation of the signal between two known positions. This reference speed W_{ref} can be evaluated over a signal duration of less than one wheel revolution. In addition, the precision of the angular resampling of the first signal Sig is improved when the tire rotates at a variable angular speed, thereby facilitating a more accurate normalization of the signal as well as an increased angular precision on the angular position of the measurement points of the first signal during the angular resampling step.

This first embodiment of the post treatment process 1100 also includes a step 1106 of normalization of the wheel rotation signal Sig_{TdR} that is obtained from the first signal Sig. During this step, the first signal Sig is normalized by a function F of the variable W_{ref} (acquired during the previous step 1104). This function F is a function that is proportional to the square of the reference speed W_{ref}. At the output of this step 1106, a normalized signal of the corresponding tractor tire 12a, 14a (and/or the corresponding trailer tire 34) over a prescribed time (for example, a predetermined number of rotations) is acquired.

During this step 1106, the reference speed W_{ref} is associated with the first acquired signal, which may be identified on this first signal or may come from another source (for example, the output of a system external to the mounted assembly incorporating the corresponding tractor tire 12a, 14a and/or the mounted assembly incorporating the corresponding trailer tire 34). This reference speed W_{ref} is necessarily associated with the same time frame as the part of the first signal. This reference speed W_{ref} is used to normalize the amplitude of the first signal using the function F. If the dependence of the amplitude of the sensor signal on the reference speed is perceived as a spurious signal of the deformation of the tire, the normalization of the sensor signal is undertaken.

This first embodiment of the process of post treatment further includes a step 1108 of resampling the normalized signal (acquired at the output of the previous step 1106) in order to recover a signal that is angularly periodic per wheel revolution. Thus, at the end of this step 1108, a normalized and angularly resampled signal over several wheel revolutions is acquired. In an alternative embodiment of the process of the invention, the process of post treatment includes a first step 1108 of resampling angularly the first signal Sig (which is also the wheel rotation signal Sig_{TdR}) (this step corresponds to the step 1108 of the first embodiment of the process). This step is performed by phasing this first signal Sig, either by using the shape of the first signal Sig or by having another signal temporally phased therewith. During this step, another signal emanates from another sensor 101, 201 or from another channel of the same sensor (such as the circumferential acceleration of a three-dimensional accelerometer). This angular resampling of the first signal Sig generates a periodic signal per wheel revolution at the output of this step 1108.

In this alternative embodiment of the process of the invention, and after phasing this angular signal with another time signal, the post treatment procedure 1100 also includes a subsequent step 1104 of determining a reference velocity W_{ref} from another time signal phased with the first signal Sig (this step corresponds to the step 1104 of the first embodiment of the disclosed process). This other time signal can be the same other signal that was used to angularly resample the first signal Sig during the previous step 1108. Thus, a reference velocity W_{ref} is identified at the output of this step 1104.

In this alternative embodiment of the process of the invention, the post treatment procedure 1100 further includes a step 1106 of using the reference speed W_{ref} to normalize the angularly resampled signal from step 1108 (this step corresponds to step 1106 of the first embodiment of the disclosed process). During this step, a function F of the variable W_{ref} is used, resulting in a normalized angularly resampled wheel revolution signal Sig_{TdR} at the output of this step 1106.

In both of the aforedescribed embodiments of the process 1000, the post treatment procedure 1100 can include an optional step 1110 of aggregating the data of the angularly normalized resampled wheel revolution signal Sig_{TdR} (this being acquired at the output of step 1108 of the first embodiment of the process or acquired at the output of step 1106 of the alternative embodiment of the process). This data aggregation is done on a sub-part of the input signal Sig that is a multiple of wheel revolutions, since the angularly resampled and normalized signal is periodic in nature.

It is therefore understood that, during the post-treatment procedure 1100, angular resampling of the first signal Sig or the wheel rotation signal Sig_{TdR} may occur before or after a normalization step. This angular resampling transforms the time signal into a spatial signal by phasing the time signal with respect to one or more angular references of the mounted assembly. This angular reference can be obtained from the first signal Sig by a specific response of the sensor 101, 201 to a particular azimuth on the wheel revolution. This angular reference can alternatively be obtained from another signal generated by a sensor that shares a common clock with the first signal Sig. This clock sharing (or “synchronization”) of signals is natural when the two sensors come from the same device or when the signals are communicated to a common device (for example, the receiver 103, 203). This angular resampling enables the generation of a spatially periodic signal per wheel revolution. In both embodiments of the process 1000, the post treatment procedure 1100 can include an optional step (not shown in FIG. 5) of performing a correction of the first signal Sig if it is polluted by known physical phenomena (for example, an accelerometer signal influenced by the earth's gravity). By correcting the first signal Sig, the influence of spurious noise generated by these physical phenomena is limited. This correction can be performed at any point between step 1102 and step 1108. For those embodiments of the invention including the data aggregation step 1108, this correction is performed prior to the data aggregation step. It is understood that, if the correction occurs after the normalization step 1106, the correction should also be normalized so as not to introduce a correction error.

The post-treatment procedure 1100 bypasses inherent variations in tire fabrication, thereby providing a means for deriving pressure data from a variety of tire manufacturers.

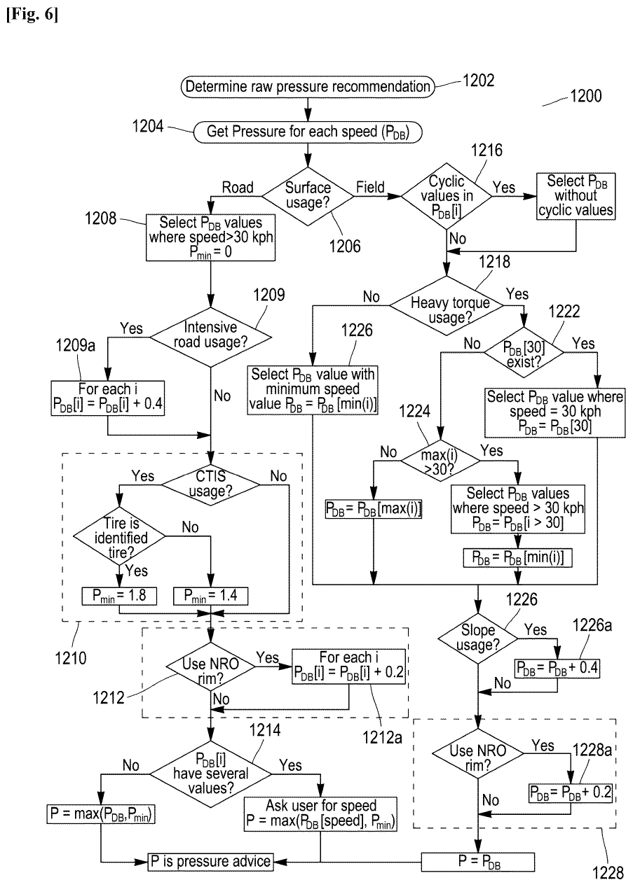

Referring still to FIGS. 4 and 5 and also to FIG. 6, the process 1000 of the invention includes an additional step of performing a pressure recommendation procedure 1200 by using the spectral criteria of each tire obtained during the post treatment procedure 1100. On the basis of the obtained spectral criteria information, as well the pressure measurement detected by the sensors 101, 201 and the usage condition provided by the operator through the user interface 104, 204, the processor can determine a recommended pressure for each tire. Referring particularly to FIG. 6, a flow diagram of the pressure recommendation procedure 1200 is provided.

The pressure recommendation procedure 1200 includes a step 1202 of determining a raw pressure recommendation advice for each speed at which the tire travels. The pressure recommendation advice that is acquired during this step can be obtained from one or more references that have been created in advance and that are known to a person of ordinary skill in the art. Such references have been created as an industry-recognized means for providing reliable tire pressure recommendation data for a variety of tire brands, tire models and tire dimensions. These references are saved (for example, in a database that is accessed by the receiver 103, 203), and they are updated for the duration of the disclosed process (either on a continuous basis or on an intermittent basis). An exemplary reference of this type is provided in Table 1:

TABLE 1

| | | | | | | | | | Air |
|---|---|---|---|---|---|---|---|---|---|
| | | | S | D | R′ | Cdr | Rim(s) | Rim(s) | chamber |
| Inches | Tire | CAI | (mm) | (mm) | (mm) | (mm) | Rec | Tol | (Code) |
| 42 | VF710/70 | 523668 | 731 | 2066 | 906 | 6104 | DW25B | DW23B | 802 |
| | R42 182D/ | | | | | | | MW25B | |
| | 179ETL | | | | | | | | |
| | P(bar) | 0.6 | 0.7 | 0.8 | 0.9 | 1.0 | 1.1 | 1.2 | 1.3 |
| Vehicle | 10 km/h | .108 | .106 | .104 | .103 | .102 | .101 | .100 | .100 |
| speed | 30 km/h | .101 | .099 | .097 | .096 | .095 | .094 | .093 | .093 |
| | 65 km/h | .099 | .097 | .095 | .094 | .093 | .092 | .092 | .091 |
| | 70 km/h | .091 | .088 | .086 | .085 | .084 | .083 | .083 | .083 |

| | | Internal | | | | | | | | |
|---|---|---|---|---|---|---|---|---|---|---|
| | | Volume | Sculpture | | | | | | | |
| | | 75% | depth | | | | | | | |
| Inches | Tire | (litres) | (mm) | | | | | | | |
| 42 | VF710/70 | 867 | 63 | | | | | | | |
| | R42 182D/ | | | | | | | | | |
| | 179ETL | | | | | | | | | |
| | P(bar) | 1.4 | 1.5 | 1.6 | 1.7 | 1.8 | 1.9 | 2.0 | Alpha | Beta |
| | | | | | | | | | (α) | (β) |
| Vehicle | 10 km/h | .100 | .099 | .099 | .098 | .096 | .095 | .094 | .1023 | −.103 |
| speed | 30 km/h | .093 | .093 | .093 | .091 | .090 | .088 | .087 | .0953 | −.103 |
| | 65 km/h | .091 | .091 | .091 | .089 | .088 | .087 | .085 | .0935 | −.104 |
| | 70 km/h | .083 | .083 | .083 | .082 | .080 | .079 | .078 | .0849 | −.096 |

Where:
“Description” refers to the identification of a particular tire;
“CAI” refers to the “Code Article International”;
“S” refers to the section length;
“D” refers to the overall diameter;
“R” refers to the loaded static radius (radius écrasé);
“Cdr” refers to the rolling circumference;
“Rim rec” refers to the recommended wheel;
“Jante tol” refers to accepted wheels; and
Alpha (α) and Beta (β) are coefficients defined for each speed.

It is understood that the values incorporated in Table 1 constitute an example and do not limit the invention in any way.

Referring again to FIG. 6, the pressure recommendation procedure 1200 includes an additional step 1204 of calculating the recommended pressure on the basis of the condition usage (for example, conditions that include one or more of high torque, intensive road usage, slope, maximum vehicle speed on the road, etc.). During this step, the determination of a recommended pressure P_{DB} is performed on the basis of a spectral criteria F_{c} that is obtained during the post treatment procedure 1100) (see FIG. 5), and on the basis of a pressure measurement P_{C} of a corresponding tractor tire 12a, 14a (and/or a pressure measurement P_{C} of a corresponding trailer tire 34) according to the following formula:

$${P}_{DB} = {[ \frac{{( {F}_{c}^{α 3} * {P}_{C}^{α 2} * α 1 )}^{\frac{1}{α 2}}}{{α}^{\frac{α 3}{α 2}} * α {1}^{\frac{1}{α 2}}} ]}^{\frac{α 2}{β * α 3 + α 2}} \qquad [ Math 2 ]$$

where a1, a2 and a3 are coefficients dedicated for a specific tire, and where a and B are defined for each line speed (see the above Table 1).

Referring further to FIG. 6, the pressure recommendation procedure 1200 includes a step 1206 of applying a selected usage condition (for example, “Road” or “Field”) to the calculated pressure obtained from the step 1204. On the basis of the selected usage condition, an algorithm is applied from which a recommended pressure is communicated to the corresponding CTIS system 105, 205. On the basis of this output, the CTIS system that receives the pressure recommendation can apply a commensurate instruction to a corresponding tire (for example, an instruction to inflate or to deflate the tire as a function of the pressure recommendation).

In an embodiment of the pressure recommendation procedure 1200 where the selected usage condition constitutes a “Road” condition (which road condition may include paved and unpaved roads), the step 1206 of applying a selected usage condition includes a step 1208 of selecting tire pressures value P_{DB} when the detected speed index i of the corresponding vehicle tire 12a, 14a (and/or the detected speed of the trailer tire 34) is greater than a predetermined minimum.

In this embodiment of the pressure recommendation procedure 1200, the step 1206 of applying a selected usage condition also includes a step 1209 of indication of whether the indicated usage condition constitutes intensive road usage (this indication is made by the operator, for example, via the user interface 104, 204). When answered in the negative (“No”), the pressure recommendation procedure 1200 continues to the next step. When answered in the positive (“Yes”), the pressure recommendation procedure 1200 includes a step 1209a of determination of an adjusted usage pressure P_{DBi} for each speed index i according to the following formula:

$${P}_{DBi} = {P}_{DBi} + 0.4 . \qquad [ Math 3 ]$$

After completion of this step 1209a, the pressure recommendation procedure 1200 continues to the next step.

In this embodiment of the pressure recommendation procedure 1200, the procedure includes a step 1210 of determination of the current state of the CTIS system (reference to “the CTIS system” includes a reference to one or both of the CTIS system 105 and the CTIS system 205). When the CTIS system is not in use (“No”), the pressure recommendation procedure 1200 continues to the next step. When the CTIS system is in use (“Yes”), the pressure recommendation procedure 1200 includes a step of indication of whether the tire concerned by the pressure recommendation is a tire identified for use with the tractor 10 (and/or identified for use with the trailer 30). The operator can verify (for example, via the user interface 104, 204) whether the identified tire is a particular tire selected for use with the vehicle (10) (and/or selected for use with the trailer 30) and having predefined operational parameters (as indicated hereinabove with respect to Table 1). When the operator indicates that the identified tire is not concerned (“No”), the system applies a minimum predefined pressure Pₘᵢₙ. When the operator verifies that the identified tire is subject to treatment by the CTIS system (“Yes”), the system applies a minimum predefined pressure P_{min′}. The pressure recommendation procedure 1200 then continues to the next step.

In this embodiment of the pressure recommendation procedure 1200, the procedure may include an optional step 1212 of determination of the current state of use of a tire having a narrow rim option (being a tire marked “NRO”). When a tire marked NRO is not in use (“No”), the pressure recommendation procedure 1200 continues to the next step. When a tire marked NRO is in use (“Yes”), the pressure recommendation procedure 1200 includes a step 1212a of determination of an adjusted usage pressure P_{DBi} for each speed index i according to the following formula:

$${P}_{DBi} = {P}_{DBi} + 0.2 . \qquad [ Math 4 ]$$

After completion of this step 1212a, the pressure recommendation procedure 1200 continues to the next step.

In this embodiment of the pressure recommendation procedure 1200, the procedure includes a step 1214 of determination of whether the adjusted usage pressure P_{DBi} has several values. When answered in the negative (“No”), the pressure recommendation procedure 1200 produces a recommended pressure P on the basis of the following formula:

$$P = max ( {P}_{DB} , {P}_{min} ) . \qquad [ M ath 5 ]$$

When answered in the positive (“Yes”), this step 1212 includes a step of interrogation (for example, an interrogation to the operator via the user interface 104, 204) for the operational speed of the tire. Upon input of this operational speed, the pressure recommendation procedure 1200 produces a recommended pressure P on the basis of the following formula:

$$P = max ( {P}_{DB} speed , {P}_{min} ) . \qquad [ Math 6 ]$$

The recommended pressure P that is communicated by the system 100, 200, 300 at the end of this step (“P is pressure advice”) denotes the end of the pressure recommendation procedure 1200.

In an embodiment of the pressure recommendation procedure 1200 where the selected usage condition constitutes a “Field” condition (which field condition may include, for example, hard and compact soil, crumbly and light soil, or wet and sticky soil), the step 1206 of applying a selected usage condition includes a step (1216) of indication of whether the indicated usage condition constitutes cyclic values for each pressure P_{DB}. It is understood by a person of ordinary skill in the art that agricultural tires may be selected in view of a cyclic loading by which they abide (that is, an anticipated load that is in constant flu during normal operation of the agricultural vehicle to which the tires are mounted). This step 1216 takes into consideration whether such tires have been selected for use in one or more of the agricultural systems 100, 200, 300.

During the step 1216, when an indication of whether the indicated usage condition constitutes cyclic values for each pressure P_{DB} is answered in the negative (“No”), the pressure recommendation procedure 1200 continues to the next step. When answered in the positive (“Yes”), the pressure recommendation procedure 1200 includes a step of selection of a pressure P_{DB} without cyclic values. This pressure is selected from references that are readily available in the industry, and such references may be included in a database that is accessible by the receiver 103, 203.

In this embodiment of the pressure recommendation procedure 1200, the step 1206 of applying a selected usage condition includes a step 1218 of indication of whether the indicated usage condition constitutes heavy torque usage (this indication is made, for example, by the operator via the user interface 103, 203). When answered in the negative (“No”), the pressure recommendation procedure 1200 includes a step 1220 of selecting a PDB value with a minimum speed value according to the following formula:

$${P}_{DB} = ( {P}_{DBmin ( i )} ) . \qquad [ Math 7 ]$$

The pressure recommendation procedure 1200 then continues to the following step. When an indication of whether the indicated usage condition constitutes heavy torque usage is answered in the positive (“Yes”), the pressure recommendation procedure 1200 includes a step 1222 of determining whether a pressure exists at a selected speed P_{DB} speed. When answered in the positive (“Yes”), this step includes a step of selection of a value for PDB according to the following formula:

$${P}_{DB} = {P}_{DBspeed} . \qquad [ Math 8 ]$$

When answered in the negative (“No”), the pressure recommendation procedure 1200 includes a step 1224 of determination of a whether a maximum speed exceeds a predefined selected speed. When answered in the negative (“No”), this step 1224 includes a step of determination of the recommended pressure P_{DB} according to the following formula:

$${P}_{DB} = {P}_{DBmax \cdot } \qquad [ Math 9 ]$$

where P_{DBmax} is a pressure at the maximum speed. When answered in the affirmative (“Yes”), this step 1224 includes a step of selection of a value for P_{DB} according to the following formula:

$${P}_{DB} = {P}_{DB ( min ( i ) \cdot } \qquad [ Math 11 ]$$

The pressure recommendation procedure 1200 then continues to the next step.

In this embodiment of the pressure recommendation procedure 1200, the step 1206 of applying a selected usage condition includes a step 1226 of indication of whether the indicated usage condition constitutes slope usage (this indication is made, for example, by the operator via the user interface 103, 203 or, in the alternative, the slope usage is detected by one or more sensors 101, 201). When answered in the negative (“No”), the pressure recommendation procedure 1200 produces a recommended pressure P on the basis of the following formula:

$$P = {P}_{DB \cdot } \qquad [ Math 12 ]$$

When answered in the positive (“Yes”), the pressure recommendation procedure 1200 includes a step 1226a of determination of an adjusted recommended pressure P_{DB} according to the following formula:

$${P}_{DB} = {P}_{DB} + 0.4 . \qquad [ Math 13 ]$$

The recommended pressure P that is communicated by the system 100, 200, 300 at the end of this step 1226a denotes the end of the pressure recommendation procedure 1200.

In this embodiment of the pressure recommendation procedure 1200, the procedure may include an optional step 1228 of determination of the current state of use of a tire marked “NRO” (as described hereinabove). In such embodiments, this step is performed after the indication of whether the indicated usage condition constitutes slope usage. In embodiments of the pressure recommendation procedure 1200 incorporating this step, when a tire marked NRO is not in use (“No”), the pressure recommendation procedure 1200 communicates the recommended tire pressure P and the procedure is completed. When a tire marked NRO is in use (“Yes”), the pressure recommendation procedure 1200 includes a step 1228a of determination of an adjusted usage pressure P_{DB} according to the following formula:

$${P}_{DB} = {P}_{DB} + 0.2 . \qquad [ Math 14 ]$$

After such determination, the adjusted usage pressure is communication as the recommended pressure P, and the pressure recommendation procedure 1200 is completed.

It is understood that the one or more steps of the process 1000, as well as the process itself, may be performed iteratively.

An example of the inventive process 1000 is given below.

### EXAMPLE

A numerical example is provided for the below tire having the following parameters:
Tire product description: VF 710/70 R42 182D/179E TL
Experimentally defined coefficients:
   a1: 70688.465
   a2: 0.700
   a3: 1.058
Spectral criteria (Fc): 0.076297197
Pressure measurement (Pc): 1.4 bar
Speed: 10 km/h
Max criteria: f(P)=α*P^{β}

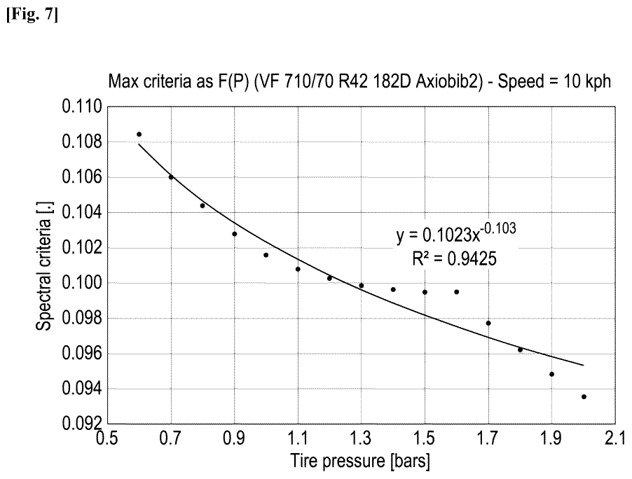

Using the values from Table 1, α=0.1023 and β=60.103 are the fitted values for line speed=10 km/h (see the spectral criteria and tire pressure relationship represented by the graph of FIG. 7).

Applying the formula [Math 2], the following pressure advice is obtained;

TABLE 2

| | | P_{DB} | |
|---|---|---|---|
| Speed | P_{DB} (bar) | rounded (bar) | Notation |
| 10 km/h | 0.88 | 0.9 | P_{DB[10]} = 0.9 (i = 10) |
| 30 km/h | 1.01 | 1.1 | P_{DB[30]} = 1.1 (i = 30) |
| 65 km/h | 1.03 | 1.1 | P_{DB[65]} = 1.1 (i = 65) |
| 70 km/h | 1.22 | 1.3 | P_{DB[70]} = 0.9 (i = 70) |

At the output of the pressure recommendation procedure 1200, the CTIS system 105, 205 can apply the recommended pressure to the corresponding tire (being one or more of the tractor tires 12a, 14a and/or one or more of the trailer tires 34). Depending on the precise configuration of the selected CTIS system, the operator may be prompted (for example, via the user interface 104, 204) to validate the recommended pressure (for example, when the recommended pressure P is significantly less than the current tire pressure). Each receiver 103, 203 can compare the current measure and the recommended pressure. When the current pressure is under the recommended pressure, the processor instructs inflation of the affected tire until the recommended pressure is attained. When the current pressure exceeds the recommended pressure, then the processor instructs deflation of the tire until the recommended pressure is attained. While the CTIS system adjusts the tire pressure, the processor receives the next update of the accelerometer signal from the sensors 101, 201 so as to repeat the procedure 1200 (compute spectral criteria, find right pressure from tire table and usage condition, compare, and apply it to the CTIS system as required).

The present invention facilitates optimal weight distribution between the front and rear axles of an agricultural vehicle so as to ensure that the slip rates are maintained in the appropriate range for the vehicle's operation in the selected conditions.

The terms “at least one” and “one or more” are used interchangeably. Ranges that are shown as being “between a and b” include both “a” and “b” values.

Although particular embodiments of the disclosed apparatus have been illustrated and described, it will be understood that various changes, additions, and modifications may be practiced without departing from the spirit and scope of this disclosure. Accordingly, no limitations should be imposed on the scope of the described invention except those set forth in the appended claims.

1.-15. (canceled)

16. A tire pressure recommendation process for controlling a central tire inflation system of an agricultural system having at least one processor in operational communication with at least one memory that is configured to execute the tire pressure recommendation process, the tire pressure recommendation process comprising a step of installation of at least one sensor along an interior surface of at least one of a vehicle tire of an agricultural vehicle and/or a trailer tire of a trailer coupled with the agricultural vehicle so as to be positioned essentially normal with respect to a respective tread of each tire, with each sensor being capable of transmitting data representative of the operational parameters of a respective tire,
wherein the at least one processor comprises an execution module that is capable of executing programming instructions that are stored in the at least one memory for performing the tire pressure recommendation process comprising the following steps:
a step of transmitting data from each sensor to a corresponding receiver of the agricultural system, with each receiver including or being in communication with the at least one processor that treats received data so as to derive spectral criteria F_{c} for at least one of a corresponding tire;
a step of performing a post treatment procedure on a signal generated by each sensor during which the spectral criteria F_{c} is obtained for the at least one tire; and
a step of performing a pressure recommendation procedure during which the spectral criteria obtained during the post treatment procedure is employed in calculating a recommended tire pressure for the at least one tire, such that, on a basis of a selected usage condition for the at least one tire, the agricultural system communicates a recommended pressure for the at least one tire to the central tire inflation system.

17. The tire pressure recommendation process of claim 16, wherein the post-treatment procedure executed by the at least one processor comprises the following steps:
a step of acquisition of a first temporal signal Sig from each sensor, wherein the first temporal signal Sig comprises at least an amplitude of at least one output signal during rotation of a corresponding tire;
a step of determination of at least one reference speed W_{ref} of the corresponding tire associated with at least a portion of a wheel rotation signal Sig_{TdR} of the corresponding tire;
a step of normalization of the wheel rotation signal Sig_{TdR} that is obtained from the first temporal signal Sig, during which step at least one part of the wheel speed signal Sig_{TdR} is normalized by a quantity that is a function F proportional to a square of the at least one reference speed W_{ref} over a predetermined number of revolutions of the corresponding tire; and
a step of resampling the normalized signal acquired at the output of the normalization step so as to obtain a signal that is angularly periodic per tire revolution.

18. The tire pressure recommendation process of claim 17, wherein the step of determination of at least one reference speed W_{ref} comprises determination of a ratio of an angular variation on a time duration separating two azimuthal positions of the at least one sensor in the corresponding tire around a natural axis of rotation from the first temporal signal Sig or from a signal phased with the first temporal signal Sig, according to the following formula:
W_{ref}=Δ(α)/Δ(t),
where α is an angular position and t is a time abscissa associated with the angular position.

19. The tire pressure recommendation process of claim 17, wherein the post treatment procedure executed by the at least one processor comprises a step of aggregating data of the angularly normalized resampled wheel revolution signal Sig_{TdR}, and
wherein the data aggregation is performed on a sub-part of the first temporal signal Sig that is a predetermined multiple of wheel revolutions.

20. The tire pressure recommendation process of claim 16, wherein the pressure recommendation procedure executed by the at least one processor comprises the following steps:
a step of determining a raw pressure recommendation advice for each speed at which the corresponding tire travels;
a step of calculating a recommended pressure for the corresponding tire; and
a step of applying the selected usage condition to the calculated pressure obtained from the step, such that, on the basis of the selected usage condition, the system communicates a recommended pressure for the corresponding tire to the central tire inflation system.

21. The tire pressure recommendation process of claim 20, wherein the step of calculation of a recommended pressure for the corresponding tire comprises a step of determination of a recommended pressure P_{DB} performed on a basis of the spectral criteria F_{c} that is obtained during the post treatment procedure and on a basis of a pressure measurement P_{C} of the corresponding tire, according to the following formula:
$${P}_{DB} = {[ \frac{{( {F}_{c}^{a 3} * {P}_{C}^{a 2} * a 1 )}^{\frac{1}{a 2}}}{{a}^{\frac{a 3}{a 2}} * a {1}^{\frac{1}{a 2}}} ]}^{\frac{a 2}{β * a 3 + a 2}} ,$$
where a1, a2 and a3 are predefined coefficients, and where a and B are defined for each line speed in the raw pressure recommendation advice.

22. The tire pressure recommendation process of claim 20, wherein the step of applying the selected usage condition executed by the at least one processor comprises the following steps:
a step of selecting tire pressures value P_{DB} when a detected speed index i of a identified tire is greater than a predetermined minimum speed;
a step of indication of whether the indicated usage condition constitutes intensive road usage,
wherein when intensive road usage is indicated, the step of applying the selected usage condition includes a step of determination of an adjusted usage pressure P_{DBi} for each speed index i according to the following formula:
$${P}_{DBi} = {P}_{DBi} + 0.4 ;$$
a step of determination of a current state of the central tire inflation system,
wherein when use of the central tire inflation system is indicated, the step includes:
a step of indication of whether the identified tire is a tire identified for use with the vehicle and/or with the trailer;
a step of verification to verify whether the identified tire is a tire selected for use with one or more of the vehicle and the trailer; and
a step of applying a minimum predefined pressure (P_{min·}, P_{min′}); and
a step of determination of whether the adjusted usage pressure P_{DBi} has several values,
wherein when the determined adjusted usage pressure P_{DBi} does not have several values, the step includes a step of producing a recommended pressure P according to the following formula:
$$P = max ( {P}_{DB} , {P}_{min} ) ,$$
and
when the determined adjusted usage pressure P_{DBi} does have several values, the step includes a step of interrogation of an operational speed of the identified tire, which step includes a step of producing a recommended pressure P according to the following formula:
$$P = max ( {P}_{DB} speed , {P}_{min} ) .$$

23. The tire pressure recommendation process of claim 20, wherein the step of applying the selected usage condition executed by the at least one processor comprises the following steps:
a step of indication of whether the indicated usage condition constitutes cyclic values for each pressure P_{DB},
wherein when cyclic values are indicated, the step of applying the selected usage condition includes a step of selecting a pressure P_{DB} without cyclic values;
a step of indication of whether the indicated usage condition constitutes heavy torque usage,
wherein when no heavy torque usage is indicated, the step of applying the selected usage condition includes a step of selecting a P_{DB} value with a minimum speed value according to the following formula:
$${P}_{DB} = ( {P}_{DB min ( i )} ) ,$$
and
when heavy torque usage is indicated, the step of applying the selected usage condition includes a step of determining whether a pressure exists at a selected speed P_{DB} speed,
wherein when a pressure at a selected speed P_{DB} speed is determined during the step, the step includes a selection of a value for P_{DB} according to the following formula:
$${P}_{DB} = {P}_{DBspeed} ,$$
and
when no pressure at a selected speed P_{DB speed} is determined during the step, the pressure recommendation procedure includes a step of determination of whether a maximum speed exceeds a predefined selected speed,
wherein when no maximum speed is determined during the step that exceeds a predefined selected speed, the step includes a determination of the recommended pressure P_{DB} according to the following formula:
$${P}_{DB} = {P}_{DBmax} ;$$
where P_{DBmax} is a pressure at the maximum speed, and
when a maximum speed is determined during the step that exceeds a predefined selected speed, the step includes a selection of a value for P_{DB} according to the following formula:
$${P}_{DB} = {P}_{DB ( min ( i )} .$$

24. The tire pressure recommendation process of claim 23, wherein the step of applying the selected usage condition includes a step of indication of whether the indicated usage condition constitutes slope usage,
wherein when no slope usage is indicated, the pressure recommendation procedure produces a recommended pressure P on the basis of the following formula:
$$P = {P}_{DB} ,$$
and
when slope usage is indicated, the pressure recommendation procedure includes a step of determination of an adjusted recommended pressure P_{DB} according to the following formula:
$${P}_{DB} = {P}_{DB} + 0.4 .$$

25. The tire pressure recommendation process of claim 16, wherein one or more steps of the process is performed iteratively.

26. An agricultural system that performs the tire pressure recommendation process of claim 16, the agricultural system comprising:
an agricultural vehicle including a front axle that serves as an axis of rotation supporting one or more front tires, and a rear axle that serves as an axis of rotation supporting one or more rear tires, with each tire having a respective tread that contacts a ground surface and being in a wheel-mounted state so as to constitute an assembly mounted in a running condition at a rotational speed W;
at least one sensor installed along an interior surface of each tire so as to be positioned essentially normal with respect to the respective tread with each sensor being capable of transmitting data representative of the operational parameters of the respective tire;
at least one receiver that receives the data transmitted by each sensor, with each receiver including or being in communication with the at least one processor so as to derive spectral criteria for at least one corresponding tire;
at least one user interface in communication with the receiver that displays tire pressure information corresponding to the signals received from the sensors and treated by the receiver during the post-treatment procedure of the tire pressure recommendation process; and
at least one central tire inflation system installed in the agricultural vehicle that permits independent adjustment of the pressure of the at least one corresponding tire.

27. An agricultural system that performs the tire pressure recommendation process of claim 16, the agricultural system comprising:
an agricultural vehicle including a front axle hat serves as an axis of rotation supporting one or more front tires, and a rear axle that serves as an axis of rotation supporting one or more rear tires, with each tire having a respective tread that contacts a ground surface and being in a wheel-mounted state so as to constitute an assembly mounted in a running condition at a rotational speed W;
a trailer coupled to the agricultural vehicle including one or more axles that serve as an axis of rotation supporting one or more trailer tires each having a respective tread that contacts the ground surface and being rotatably mounted in a wheel-mounted state so as to constitute an assembly mounted in a running condition at a rotational speed W′;
at least one sensor installed along an interior surface of each trailer tire so as to be positioned essentially normal with respect to the respective tread with each sensor being capable of transmitting data representative of the operational parameters of the respective trailer tire;
at least one receiver that receives the data transmitted by each sensor, with each receiver including or being in communication with the at least one processor so as to derive spectral criteria for at least one corresponding trailer tire;
at least one user interface in communication with the receiver that displays tire pressure information corresponding to the signals received from the sensors and treated by the receiver during the post-treatment procedure of the tire pressure recommendation process; and
at least one central tire inflation system installed in the trailer that permits independent adjustment of the pressure of the at least one corresponding trailer tire.

28. An agricultural system that performs the tire pressure recommendation process of claim 16.

29. The agricultural system of claim 26, wherein the sensor comprises an accelerometer that is capable of detecting temperature and/or pressure values in an interior of at least one tire.

30. The agricultural system of claim 26, wherein the agricultural vehicle further comprises at least one of:
one or more implements attached to the front axle; and
one or more implements attached to the rear axle.
